(19) United States
(12) Patent Application Publication
(10) Pub. No.: US 2010/0011996 A1
(43) Pub. Date: Jan. 21, 2010

(54) RECEPTACLE

(75) Inventors: Craig Marwood, Caledon (CA); Erich Genseberger, Caledon (CA)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: ECOMEDIA DIRECT INC., Toronto (CA)

(21) Appl. No.: 12/175,885

(22) Filed: Jul. 18, 2008

(51) Int. Cl. A47B 96/00; A47B 95/00; G06F 7/00; B65D 21/02

(52) U.S. Cl. 108/26; 108/33; 248/345; 700/213; 220/23.91

(57) ABSTRACT

A portable receptacle is provided comprising a body and a cover. The cover is removable form the body. The body is collapsible into a position suitable for stacking and/or shipping. The cover can be folded. A plurality of covers can be created for a single body. Each cover can include a message.

### FIELD

This specification relates to receptacles and more particularly relates to a portable receptacle that is collapsible and stackable.

### BACKGROUND

Social events such as concerts, conferences or rallies, play an important role in any society. The gathering of a large group of people allows those with like interests to interact and share. Social events increase social cohesion, which in turn increases social harmony. Social events are also ideal venues for merchants to advertise their wares. Event organizers can use the advertisement revenue to help pay for the various expenses of organizing such events. One such expense is the cost of waste management.

Recycling has become an integral part of waste management. Waste is sorted to enable its transport to proper destination. One method of sorting is to encourage the person who disposes the waste to place it in the proper container. Bins for specific types of waste, such as plastic, paper, metal containers, organic material, and the like can be placed at strategic locations to collect the waste. However, there are shortcomings with placement of a plurality of bins at strategic locations. For example, it can be quite taxing to label bins to indicate its content and to secure bins to reduce spillage and vandalism. The number of people attending events can also vary, making it difficult to ensure that there are a sufficient number of permanent bins to collect the waste generated at the event.

### SUMMARY

An aspect of the specification provides a portable receptacle, comprising a platform and a plurality of legs attached to the platform. Each of the legs has an upper and lower portion, and the upper portion has a connecting point. There is also provided at least one frame operable in first and second mode. The frame has at least one support portion and a canopy portion. The support portion has a first end and a second end. The first end is attachable to the connecting point, and the second end is joined to the canopy portion. The connecting point is configured to enable the frame to switch between the first mode and the second mode. The receptacle also comprises a removable cover configured to rest on at least the canopy portion, such that when the frame is situated in the first mode, the frame is coplanar to the platform and when the frame is situated in the second mode, the frame is substantially perpendicular to the platform for resting the cover on the canopy.

The receptacle can be used for a variety of purposes, such as disposing of waste or garbage or for receiving materials that are to be recycled or composted.

The portable receptacle can include a foot attached to the lower portion of the legs. The upper portion of the legs can be dimensioned to receive the foot for stacking the platform. The connecting point can comprise a pin to attach the first end to the upper portion and a slot on the first end to enable the pin to traverse in the slot longitudinally to the first end. The connecting point can also comprise a hole in the upper portion such that the upper portion is attached to the first end by inserting the pin through the hole and the slot. The canopy portion can slope from a first side to a second side.

The platform can be configured to support at least one bin. The cover can thus include an access opening for each bin so that refuse can be inserted into each access hold and will fall into a corresponding bin. The openings can be situated at the first side.

The cover can be rigid or flexible.

The at least one beam rests can span the distance between two of the legs.

At least two beams can be provided and to rest on the high point, so that the beams span the distance between two of the legs. In place of the beams, a single solid top piece can be provided.

At least four legs can be attached to the platform.

The upper portion can have a hollow to receive the first end, the upper portion having a cutout. The cutout is dimensioned to enable the frame to switch from the first mode to the second mode. The first end has a first segment, a second segment, and a third segment. The first segment containing the slot and is joined to the second segment at a first angle. The second segment is joined to the third segment at a second angle, such that when the first segment and second segment are inserted into the hollow, the frame is locked in the second mode and when the second segment is lifted above a narrowest width of the cutout, the frame is unlocked from the second mode.

Another aspect of the specification provides a portable receptacle, comprising a platform and four legs attached to the platform. Each of the legs has an upper and lower portion and the upper portion has a connecting point. Two frames are provided that operable in first and second mode. The frame has two support portions and a canopy portion. The support portion has a first end and a second end. The first end is attachable to the connecting point, and the second end is joined to the canopy portion. The connecting point is configured to enable the frame to switch between the first mode and the second mode. The receptacle also comprises a removable cover configured to rest on the canopy portion such that when the frame is situated in the first mode, the frame is coplanar to the platform and when the frame is situated in the second mode, the frame is substantially perpendicular to the platform for resting the cover on the canopy.

Another aspect of the specification provides a portable receptacle, comprising a platform and four legs attached to the platform, each of the legs having an upper and lower portion, the upper portion having a connecting point and two frames operable in first and second mode. The frame has two support portions and a canopy portion. The support portion has a first end and a second end. The first end is attachable to the connecting point and the second end is joined to the canopy portion. The connecting point is configured to enable the frame to switch between the first mode and the second mode, such that when the frame is situated in the first mode, the frame is coplanar to the platform and when the frame is situated in the second mode, the frame is substantially perpendicular to the platform for resting the cover on the canopy.

Another aspect of the specification provides an exchange system for bodies and covers of receptacles comprising a computing environment comprising at least one central processing unit, memory and an interface interconnected by a bus. The central processing unit is configured to receive, via the interface, first data representing a first order for at least one body for a receptacle. The first order originates from a first entity and comprises first compensatory terms. The central processing unit is configured to receive, via the interface, second data representing a second order for at least one cover for the receptacle. The second order originates from a second entity and comprises second compensatory terms. The central processing unit is configured to perform a comparison of the first data and the second data and to perform an adjustment the first compensatory terms based the comparison. The central processing unit is configured to generate third data representing the first order including the adjustment and the second order.

A portable receptacle is provided comprising a body and a cover. The cover is removable form the body. The body is collapsible into a position suitable for stacking and/or shipping. The cover can be folded. A plurality of covers can be created for a single body. Each cover can include a message.

Another aspect of the specification provides a disposable receptacle comprising a body having a platform and a frame connected to the platform. The frame is movable between a collapsed position and a raised position in relation to the frame. The platform is configured to support at least one bin. The receptacle also comprises a cover configured to rest on the frame when the frame is in the raised position. The cover comprises at least one opening providing access to the bins. The cover is removable from the frame.

### BRIEF DESCRIPTION OF THE DRAWINGS

FIG. 1 is a perspective view of a portable receptacle with the cover of the receptacle exploded from the body of the receptacle.

FIG. 2 is a perspective view of the body of the receptacle shown in FIG. 1.

FIG. 3 is a platform of the body of the receptacle shown in FIG. 2.

FIG. 4 is a perspective view of the body of FIG. 2 shown in a partially collapsed state.

FIG. 5 is a bottom perspective view of the body of FIG. 2.

FIG. 6 is a perspective view of receptacle of FIG. 1 with the body in a collapsed state and the cover stored on the body.

FIG. 7 is a perspective view of the receptacle of FIG. 1 with the cover disposed over the body.

FIG. 8 is a perspective view of one of the footings and a portion of the beam associated with that footing exploded from the footing, all from the receptacle shown in FIG. 1.

FIG. 9 is a perspective view of the footing of FIG. 8 with the beam in a collapsed position.

FIG. 10 shows a range of movement from the beam from FIG. 8 and FIG. 9.

FIG. 11 shows the footing and beam portion from FIG. 8 with the beam attached to the footing.

FIG. 12 shows a range of movement from the beam from FIG. 8 and FIG. 9 opposite from the range of movement of FIG. 10.

FIG. 13 shows a stacked plurality of the receptacles from FIG. 6.

FIG. 14 shows an exchange system for bodies and covers of receptacles, according to a non-limiting embodiment.

FIG. 15 shows a method for processing orders for receptacles, according to a non-limiting embodiment.

### DETAILED DESCRIPTION OF THE EMBODIMENTS

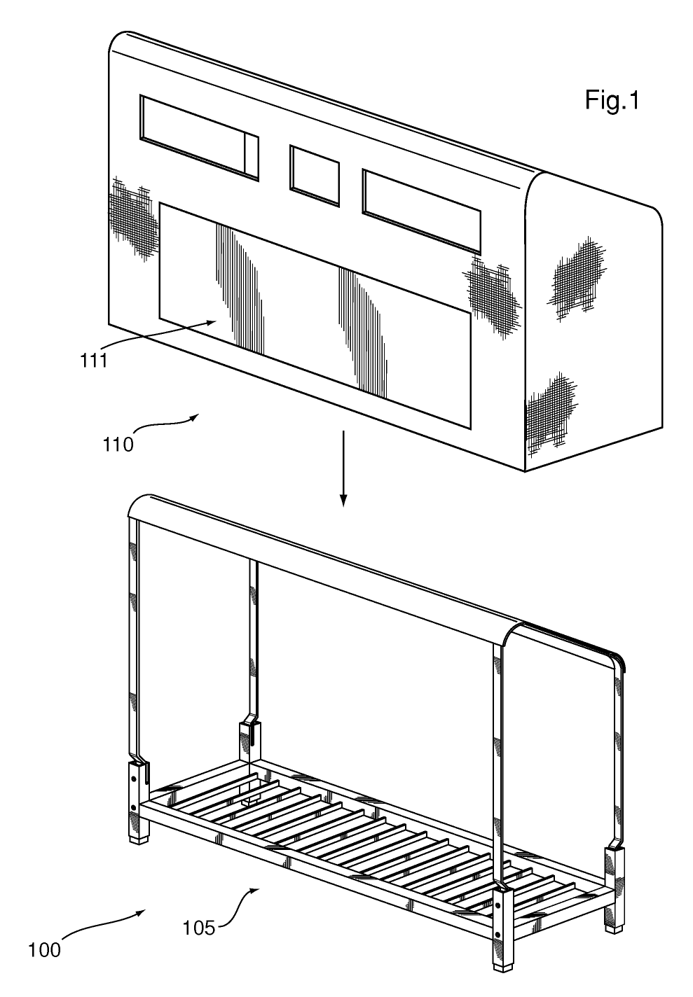

Referring to FIG. 1, a portable receptacle in accordance with a first embodiment is indicated generally at 100. Receptacle 100 comprises a body 105 and a cover 110. Cover 110, in a present embodiment, is made from a fabric or fabric-like material, and is preferably made of natural (e.g. cotton) or man-made (e.g. polyester) material. Cover 110 in a present embodiment is flexible, but can be rigid in other embodiments.

Cover 110 optionally includes a message 111 one on or more of its surfaces. (Indeed, while FIG. 1 shows message 111 on only one surface, message 111 can in fact comprises one or more messages that cover any portion, or the entirety of, cover 110.) Message 111 can be any type of message, including, by way of non-limiting example, an advertisement, a logo, a trademark, a public service announcement or the like. As will be explained in more detail below, cover 110 is removable from body 105, and body 105 is collapsible and stackable. Receptacle 100 is operable in a first mode and a second mode. The first mode corresponds to receptacle 100 in a collapsed state. The second mode corresponds to receptacle 100 in an erect state.

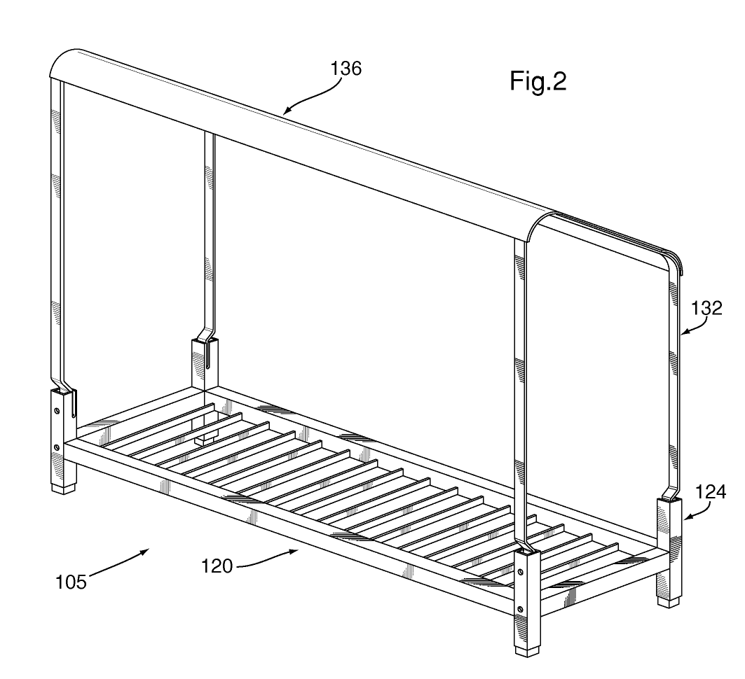

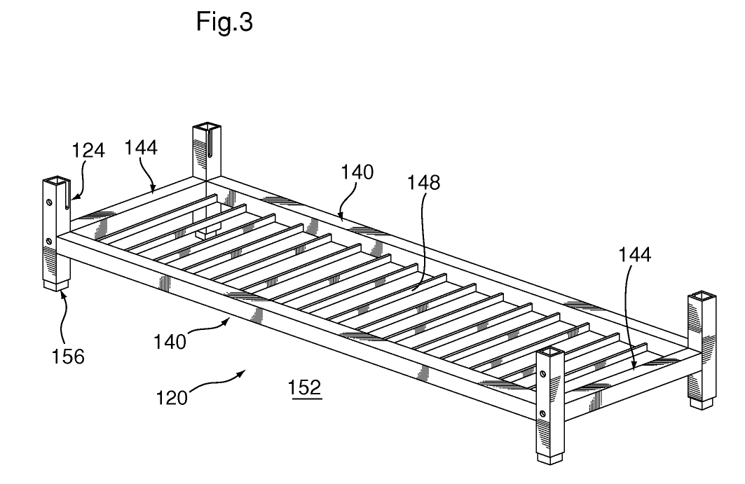

Referring to FIG. 2, body 105 is shown in isolation without cover 110. Body 105 comprises a platform 120, a plurality of legs 124, a plurality of frames 132, and a plurality of beams 136. (In other embodiments the plurality of beams 136 can be replaced with a single beam or a single top piece). As best seen in FIG. 3, platform 120 and legs 124 are shown in isolation from frames 132 and beams 136. Platform 120 is a rectangular structure, whose borders comprise two lengthwise rectangular structural tubes 140 and two widthwise rectangular structural tubes 144. A plurality of widthwise rods 148 are situated within the borders of platform 120 to provide a surface to support the contents of receptacle 100. (Rods 148 can be replaced with a solid sheet of planar material or other supporting surface). (As will be explained further below, such contents are typically a plurality of bins 150 that correspond to different types of waste.) Legs 124 elevate platform 120 from a supporting surface 152, such as the ground or a floor. Each leg 124 is attached to a corner of platform 120. Each leg 124 has an upper portion and a lower portion. A foot 156 is attached to the lower portion of leg 124. Foot 156 rests upon supporting surface 152. Foot 156 is also configured to provide a stacking function, the details of which will be discussed further below.

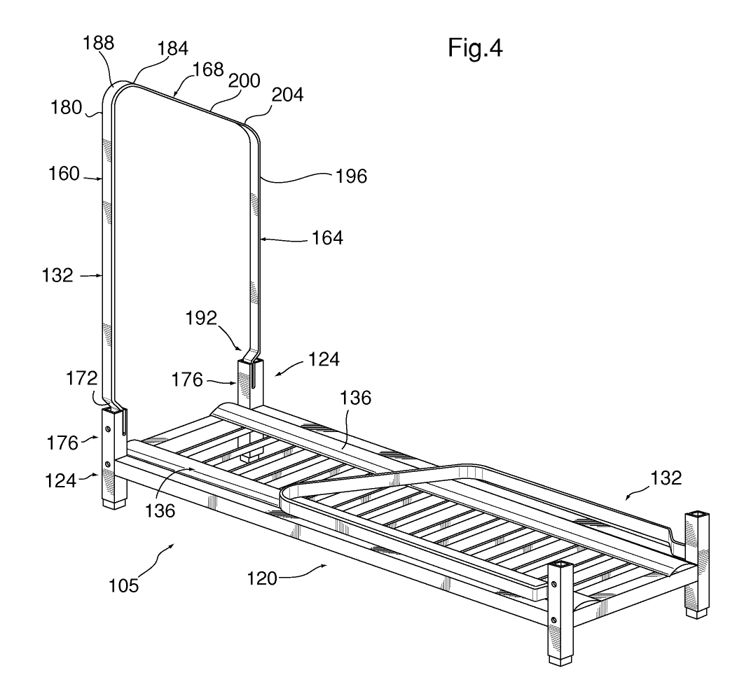

Referring to FIG. 4, body 105 is shown in a semi-collapsed state. Each frame 132 comprises, in a present embodiment, a contiguous piece of material comprised of a first support portion 160, a second support portion 164 and a canopy portion 168. The support portions 160, 164 and the canopy portion 168 form an arch. In other embodiments, other shapes other than an arch are contemplated. A first end 172 of the first support portion 160 is attached to leg 124 at a connecting point 176 on the upper portion of leg 124, as will be explained in more detail below. A second end 180 of the first support portion 160 joins with a first end 184 of the canopy portion 168 at a first junction 188. Likewise, a first end 192 of the second support portion 164 is attached to leg 124 at the connecting point 176. A second end 196 of the second support portion 164 joins a second end 200 of the canopy portion 168 at a second junction 204. In the present embodiment, the canopy portion 168 slopes from the first junction 188 to the second junction 204.

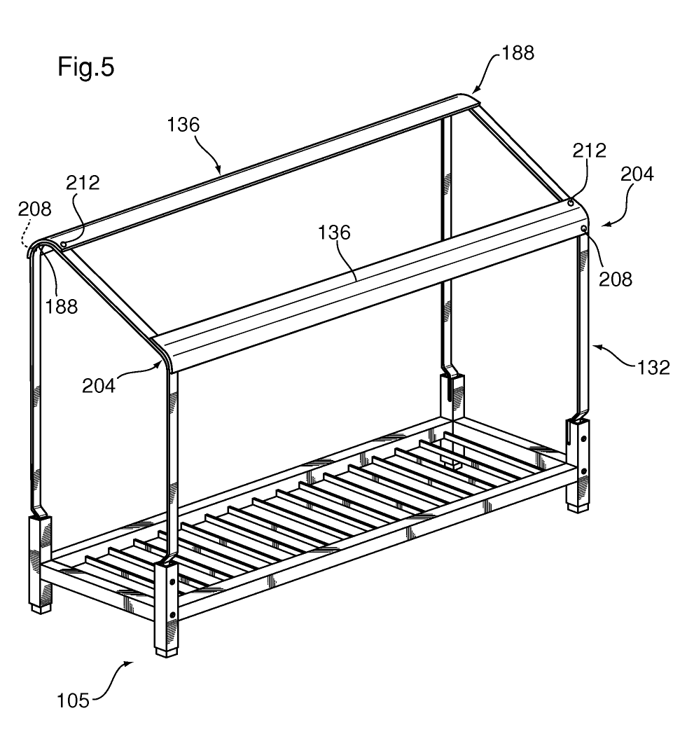

As can be best seen in FIG. 5, body 105 is shown from another view to illustrate the locations of beams 136 when body 105 is in an erect state. In the present embodiment, beams 136 are removably affixed to frames 132 with nuts and bolts (or any other type of suitable fastener) at the junctions 188, 204. Each beam spans the distance between the frames 132. At each junction 188, 204, beam 136 is attached to frame 132 at a first attachment point 208 and a second attachment point 212. The first attachment points 208 are located on support portions 106, 164. The second attachment points 212 are located on canopy portion 168. Nuts and bolts enables beams 136 to be removed from the attachment points 208, 212. However, it is apparent to a person skilled in the art that other types of fasteners or methods for removably affixing beams 136 to frames 132, such as clips and butterfly nuts, are well within the scope of the present application.

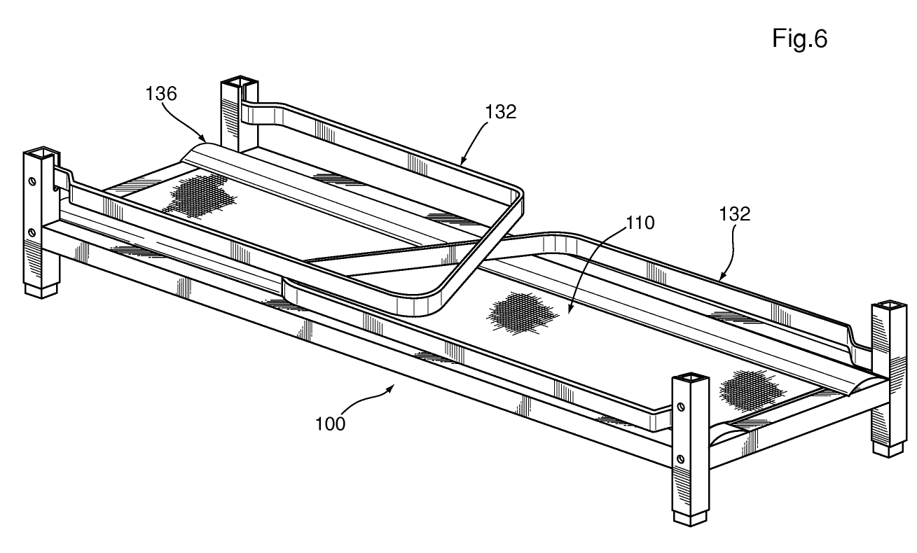

Referring to FIG. 6, receptacle 100 is shown in the first mode, cover 110 is folded and placed along with beams 136 on platform 120. In the present embodiment, beams 136 are placed near the lengthwise edge of platform 120 with cover 110 resting between beams 136. One frame 132, resting on beams 136, provides a support for the other frame 132 to rest on. However, it will now be apparent to a person skilled in the art that cover 110 can be flexible or rigid and the placement of the beams and cover 110 may be in other configurations and orders.

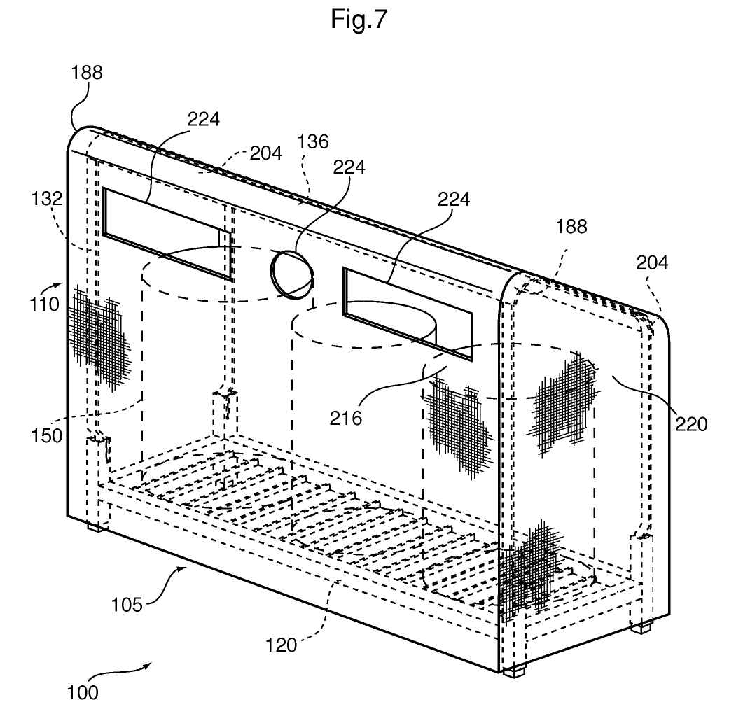

Referring to FIG. 7, receptacle 100 is shown in the second mode, frames 132 are situated substantially perpendicular to platform 120. Beams 136 are affixed to frames 132 at junctions 188, 204, as described above. In a present embodiment, three bins 150 are placed on platform 120. Cover 110 is placed over body 105. The shape of the bins 150 in FIG. 7 are shown as cylindrical, but it should be understood that that the shape of the bin is not particularly limited. Receptacle 100 has a first side 216 and a second side 220 corresponding to the lengthwise borders of receptacle 100. The first side 216 corresponds to the side where the first junctions 188 are situated. The second side 220 corresponds to the side where the second junctions 204 are situated. Three openings 224 are situated on cover 110 on the first side 216, corresponding to the location of the bins, to enable articles to be deposited into the bins through the openings 224. However, it will be apparent to a person skilled in the art that the number of bins and/or openings may be varied, to comprise one, two or more openings and/or bins. Typically, each opening or bin is respective to a type of material. For example, one opening can be respective to garbage, another respective to organic material for composting, and a third opening can be respective to glass, paper or other recyclable materials. Message 111 can include an indication as to the intended purpose for each opening.

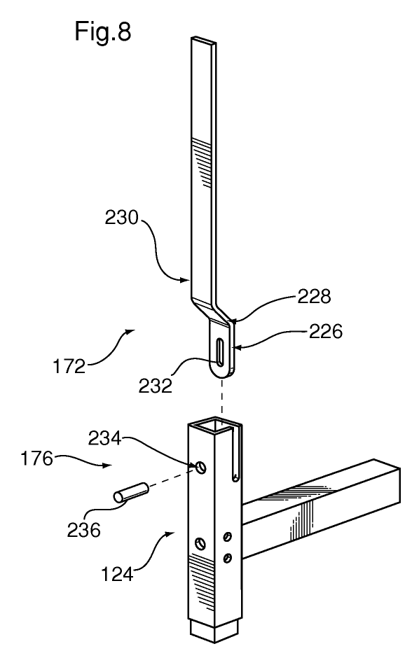

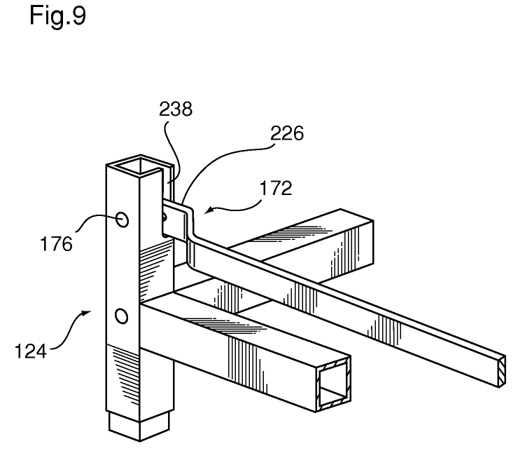

Referring to FIG. 8, an exemplary embodiment of the unassembled components making up the mechanism that enables receptacle 100 to switch between first and second mode is shown in isolation. (It should be understood that other types of configurations to permit switching between the first and second mode are contemplated). The first end 172 is shown isolated from support portions 160, 164. First end 172 comprises a first segment 226, a second segment 228, and a third segment 230. First segment 226 contains a slot 232. A first end of first segment 226 joins a first end of second segment 228 at a first angle. A second end of second segment 228 joins a first end of third segment 230 at a second angle. Leg 124 contains a hole 234. Leg 124 is hollow to receive first segment 226. With first segment 226 inserted into leg 124, a pin 236 is inserted through hole 234 and slot 232 to affix first end 172 to leg 124 at connecting point 176 (as shown in FIG. 9). (As will be explained further below, slot 232 is dimensioned to enable first segment 226 to slide on pin 236 in a direction perpendicular to pin 236.)

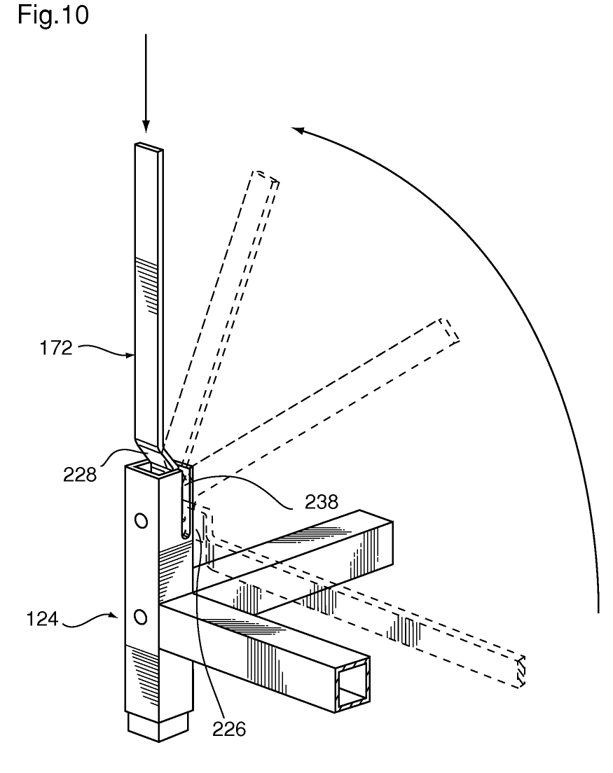

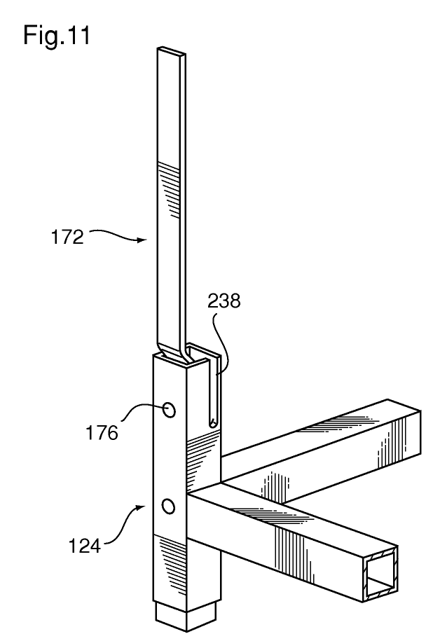

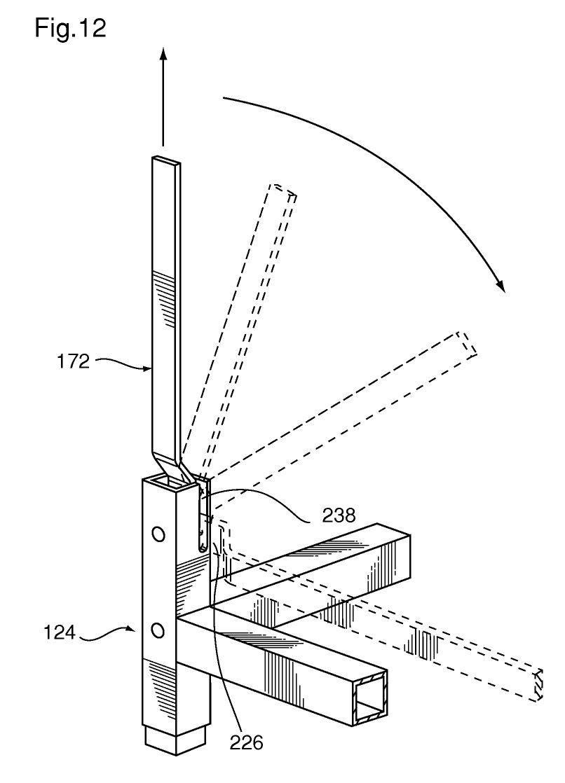

Referring to FIG. 9, FIG. 10, FIG 11, and FIG. 12, each FIG. shows a portion of body 105 to illustrate how receptacle 100 switches between first and second mode. FIG. 9 shows receptacle 100 in first mode, first end 172 is affixed to leg 124 at connecting point 176. Leg 124 contains a cutout 238. Cutout 238 is dimensioned to enable first segment 226 pass through it. FIG. 10 shows receptacle 100 switching from first mode to second mode travelling in an arc. When first end 172 arrives at the end of the arc, first segment 226 and second segment 228 are inserted into leg 124. With both first segment 226 and second segment 228 inserted into leg 124, the configuration of first segment 226 and second segment 228 prevents first end 172 from passing through cutout 238 (as shown in FIG. 11). FIG. 11 shows receptacle 100 in second mode. Referring to FIG. 12, receptacle 100 is shown switching from second mode to first mode. To switch from second to first mode, first end 172 is lifted. Slot 232 enables first end 172 to travel perpendicular to pin 236. Lifting first end 172, frees second segment 228 from leg 124, enabling first segment 226 to pass through cutout 238 as frame 132 travels in an arc to second mode.

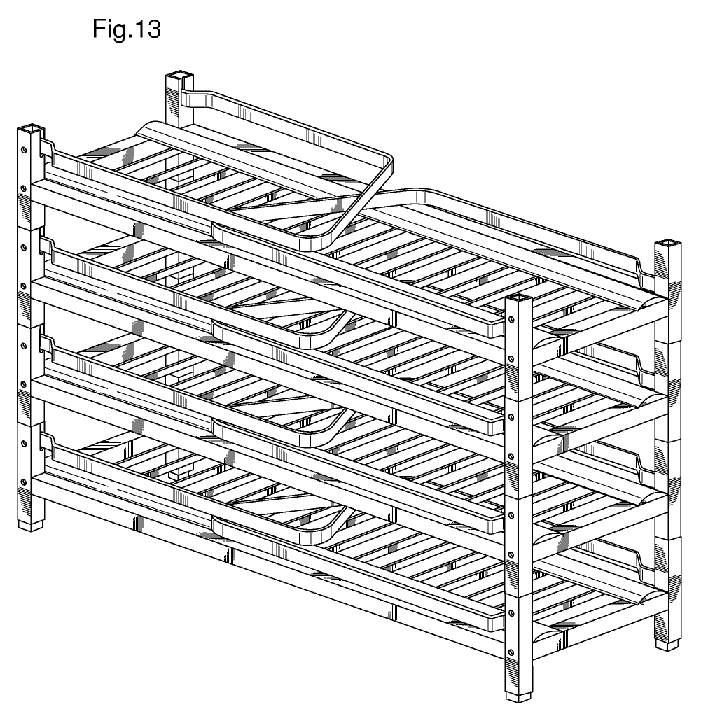

The operation of receptacle 100 will now be described. When not in used, receptacle 100 is switched to first mode as shown in FIG. 6. To conserve space, receptacle 100 may be stacked on top of each other as shown in FIG. 13. Feet 156 (see FIG. 3) are inserted into leg 124 to align and stabilize the stacked receptacles 100 (see FIG. 13). When the service of receptacle 100 is required, receptacle 100 is moved to the desired location. Frames 132 are switched from second mode to first mode as described above. Beams 136 are attached to frames 132 as described above. Bins 150 are placed on platform 120 as described above. Body 105 is covered with cover 110 with openings 224 situated on cover 110 on the first side 216, corresponding to the location of the bins, to enable articles to be deposited into the bins through the openings 224. When the service of receptacle 100 is no longer required, receptacle 100 is switched to first mode. Cover 110 is folded and placed along with beams 136 on platform 120. In the present embodiment, beams 136 are placed near the lengthwise edge of platform 120 with cover 110 resting between beams 136. One frame 132, resting on beams 136, provides a support for the other frame 132 to rest on. Receptacle 100 is then stacked as shown in FIG. 13.

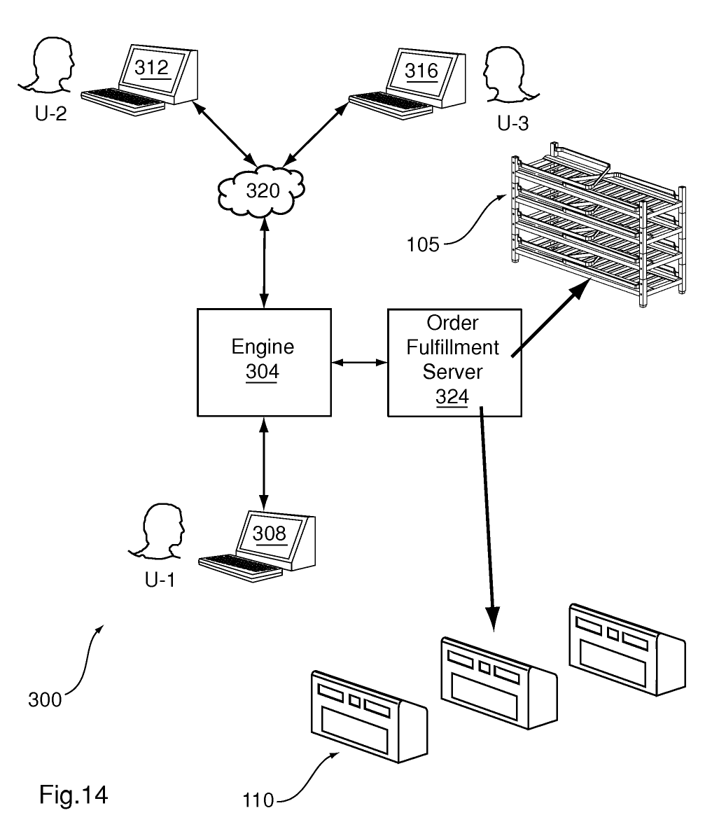

Referring now to FIG. 14, an exchange system for bodies (such as body 105) and covers (such as covers 110) of receptacles (such as receptacle 100) is indicated generally at 300. System 300 comprises an exchange engine 304 that is based on any suitable computing environment, with appropriate hardware configurations (e.g. one or more servers) consisting of an arrangement of central processing unit(s), volatile memory (e.g. random access memory), non-volatile memory (e.g. hard disk drives), network interface(s) all interconnected by a bus. The computing environment also comprises appropriate an operating system and one or more software processes in accordance with the teachings herein.

Engine 304, in a present embodiment, is connected to a first terminal 308, which can be used for administering engine 304 including monitoring exchange activity conducted thereon. Terminal 308 can be any combination of input devices (e.g. keyboard, mouse etc.) and output devices (e.g. monitor, printer, speakers) that are connectable to engine 304. Engine 304 is also connected to a plurality of additional terminals 312, 316 via a network 320. Network 320 can be the Internet or any other type of wide area network. Terminals 312 and 316 can be any type of computing device, such as a desk top computer or laptop computer. Where network 320 is the Internet, then engine 304 can host web-pages that are accessible via web-browsers on terminal 312 and terminal 316 in order to place orders for bodies 105 and covers 110.

As will be explained in greater detail below, engine 304 is configured to receive and process orders for bodies 105 and covers 110, which are typically received from terminal 312 and/or terminal 316.

Engine 304 is also connected to an order fulfillment server 324 which can be based on a computing environment similar to engine 304. As will be explained in greater detail below, order fulfillment server 324 is configured to respond to orders for bodies 105 and covers 110 so as to generate invoices and/or shipping manifests and/or customization requests so that bodies 105 and covers 110 are built and/or delivered in accordance with the orders processed by engine 304.

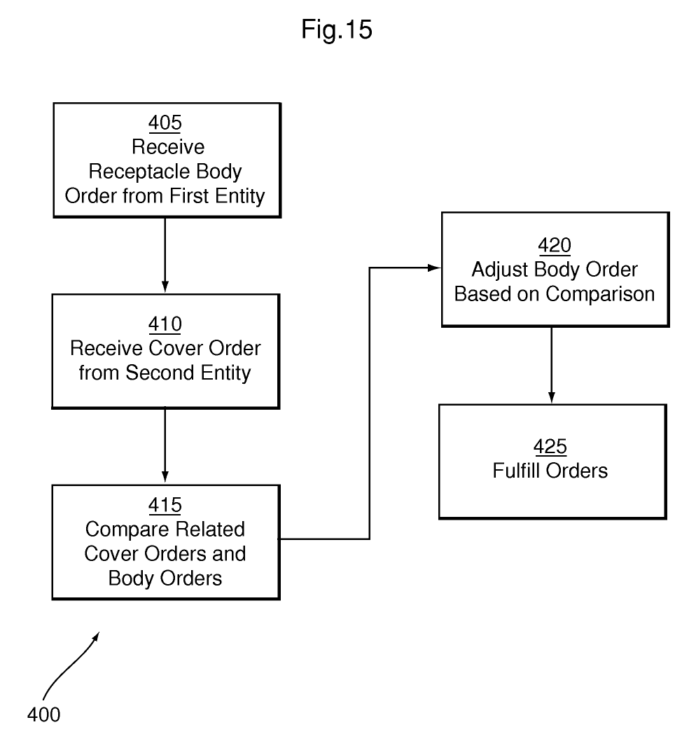

Referring now to FIG. 15, a computer-implemented method for processing orders for receptacles is depicting in the form of a flow-chart and indicated generally at 400. Method 400 can be implemented using system 300, and for purposes of further understanding method 400 and system 300, the performance of method 400 will be explained in relation to system 300. It should be understood, however, that both method 400 and system 300 can be varied.

Block 405 comprises receiving receptacle body orders from a first entity. Block 405 can be implemented by, for example, user U-2 operating terminal 312 to place an order for at least one body 105. User U-2 will thus typically be a representative of the first entity. The first entity can be any entity that has the cause, need, desire or mandate to provide receptacles. A municipality is one example of a first entity. Another example is a special events operator, such as a concert promoter or the like. The order submitted at block 405 will typically include a quantity of bodies 105, and compensatory terms associated with the order. Such compensatory terms can include outright purchase or rental or “rent-to-own” or combinations thereof or any other compensatory terms that will now occur to those skilled in the art. Receptacle body orders placed at block 405 are received and maintained at engine 304.

Block 410 comprises receiving cover orders from a second entity. Block 410 can be implemented by, for example, user U-3 operating terminal 316 to place an order for at least one cover 110. User U-3 will thus typically be a representative of the second entity. The first entity can be any entity that has the cause, need, desire or mandate to convey a message (such as message 111) individuals using receptacles 100. A commercial entity is one example of a second entity, where that commercial entity wishes to have a message 111 that advertises wares or services. Another example is a government agency, where that government agency wishes to have a message 111 that promotes a particular government policy. The order submitted at block 410 will typically include a quantity of covers 110 (that may correspond with specific orders for bodies 105 received at block 405), messages 111 to be printed on each cover 110, and compensatory terms associated with the order. Such compensatory terms can comprise an outright purchase of the cover, or rental or “rent-to-own” or a combination of purchase of covers, and then a rental-fee for placement of those covers 110 over various bodies 105 that were ordered at block 405. The rental-fee can in effect be a fee for the privilege of conveying message 111 to the individuals using receptacle 100. Other compensatory terms that will now occur to those skilled in the art. Cover orders placed at block 410 are received and maintained at engine 304.

Block 415 comprises comparing the body orders from block 405 with the cover orders from block 410. The comparison at block 415 is performed by engine 304 based on data received at blocks 405 and 410. The comparison comprises matching orders for covers 110 from block 410 that are to be used to cover specific bodies 105 from block 405. The comparison will include an examination of the compensatory terms received in relation to those matched orders.

Block 420 comprises adjusting the body order from block 405 based on the comparison at block 415. Block 420 is performed by engine 304. The adjusting typically involves a reduction of the compensatory terms from block 405 by an amount that reflects the recovery of the reduction within the compensatory terms from block 410. In this manner, the second entity serves to subsidize the acquisition of the bodies 410 by the first entity. Where the order at block 410 is of sufficient size, it is possible that the compensatory terms from block 405 would be reduced to zero, or would even include a compensation being provided back to the first entity.

Note that blocks 410 through block 420 can repeat multiple times in relation to a single order from block 405.

Block 425 comprises fulfilling of the orders. Block 425 can be effected by engine 304 forwarding the results from blocks 405-420 to fulfillment server 324. Fulfillment server 324 can generate appropriate electronic instructions to, for example, a) send orders to a manufacturer of to produce bodies 105 in accordance with the order received at block 405, b) send orders to a manufacturer to produce covers 110, including preparation of appropriate messages on those covers 110, in accordance with the order received at block 410, c) send invoices to the first and second entities, and in particular where the invoices to the first entity include the adjustment from block 420, d) send shipping instructions for destinations for bodies 105 and covers 110 in accordance with the orders received at block 405 and block 410.

While foregoing describes various embodiments, it should be understood that variations, sub-sets and combinations of those embodiments are contemplated. For example, it should be understood that cover 110 can be used in conjunction with the recycling bin described in U.S. Pat. No. 6,193,091.

1. A portable receptacle, comprising:
a platform;
a plurality of legs attached to said platform, each of said legs having an upper and lower portion, said upper portion having a connecting point;
at least one frame operable in first and second mode, said frame having at least one support portion and a canopy portion, said support portion having a first end and a second end, said first end attachable to said connecting point, said second end joined to said canopy portion, said connecting point configured to enable said frame to switch between said first mode and said second mode;
a removable cover configured to rest on at least said canopy portion;
such that when said frame is situated in said first mode, said frame is coplanar to said platform and when said frame is situated in said second mode, said frame is substantially perpendicular to said platform for resting said cover on said canopy.

2. The portable receptacle of claim 1 wherein a foot is attached to said lower portion of said legs, said upper portion of said legs is dimensioned to receive said foot for stacking said platform.

3. The portable receptacle of claim 2 wherein said connecting point comprises:
a pin to attach said first end to said upper portion;
a slot on said first end to enable said pin to traverse in said slot longitudinally to said first end:
a hole in said upper portion;
such that said upper portion is attached to said first end by inserting said pin through said hole and said slot.

4. The portable receptacle of claim 3 wherein said canopy portion slopes from a first side to a second side.

5. The portable receptacle of claim 4 wherein said platform supports at least 1 bin.

6. The portable receptacle of claim 4 wherein said platform supports at least 3 bins.

7. The portable receptacle of claim 5 wherein said cover has openings respective to each bin, said openings are situated at said first side.

8. The portable receptacle of claim 7 wherein said cover is rigid or flexible.

9. The portable receptacle of claim 7 wherein at least one beam rests on said high point, said beam spanning the distance between two of said legs.

10. The portable receptacle of claim 7 wherein at least 2 beams rests on said high point, said beams spanning the distance between two of said legs.

11. The portable receptacle of claim 1 wherein at least 4 legs are attached to said platform.

12. The portable receptacle of claim 3 wherein said upper portion has a hollow to receive said first end, said upper portion having a cutout, said cutout dimensioned to enable said frame to switch from said first mode to said second mode, said first end having a first segment, second segment, and third segment, said first segment containing said slot, said first segment joined to said second segment at a first angle, said second segment joined to said third segment at a second angle, such that when said first segment and second segment are inserted into said hollow, said frame is locked in said second mode and when said second segment is lifted above a narrowest width of said cutout, said frame is unlocked from said second mode.

13. A portable receptacle, comprising:
a platform;
four legs attached to said platform, each of said legs having an upper and lower portion, said upper portion having a connecting point;
two frames operable in first and second mode, said frame having two support portions and a canopy portion, said support portion having a first end and a second end, said first end attachable to said connecting point, said second end joined to said canopy portion, said connecting point configured to enable said frame to switch between said first mode and said second mode;
a removable cover configured to rest on said canopy portion;
such that when said frame is situated in said first mode, said frame is coplanar to said platform and when said frame is situated in said second mode, said frame is substantially perpendicular to said platform for resting said cover on said canopy.

14. The portable receptacle of claim 13 wherein said connecting point comprises:
a pin to attach said first end to said upper portion;
a slot on said first end to enable said pin to traverse in said slot longitudinally to said first end:
a hole in said upper portion;
such that said upper portion is attached to said first end by inserting said pin through said hole and said slot.

15. The portable receptacle of claim 14 wherein said upper portion has a hollow to receive said first end, said upper portion having a cutout, said cutout dimensioned to enable said frame to switch from said first mode to said second mode, said first end having a first segment, second segment, and third segment, said first segment containing said slot, said first segment joined to said second segment at a first angle, said second segment joined to said third segment at a second angle, such that when said first segment and second segment are inserted into said hollow, said frame is locked in said second mode and when said second segment is lifted above a narrowest width of said cutout, said frame is unlocked from said second mode.

16. The portable receptacle of claim 13 wherein a foot is attached to said lower portion of said legs, said upper portion of said legs is dimensioned to receive said foot for stacking said platform.

17. A portable receptacle, comprising:
a platform;
four legs attached to said platform, each of said legs having an upper and lower portion, said upper portion having a connecting point;
two frames operable in first and second mode, said frame having two support portions and a canopy portion, said support portion having a first end and a second end, said first end attachable to said connecting point, said second end joined to said canopy portion, said connecting point configured to enable said frame to switch between said first mode and said second mode;
such that when said frame is situated in said first mode, said frame is coplanar to said platform and when said frame is situated in said second mode, said frame is substantially perpendicular to said platform for resting said cover on said canopy.

18. The portable receptacle of claim 17 wherein said connecting point comprises:
a pin to attach said first end to said upper portion;
a slot on said first end to enable said pin to traverse in said slot longitudinally to said first end:
a hole in said upper portion;
such that said upper portion is attached to said first end by inserting said pin through said hole and said slot.

19. The portable receptacle of claim 18 wherein said upper portion has a hollow to receive said first end, said upper portion having a cutout, said cutout dimensioned to enable said frame to switch from said first mode to said second mode, said first end having a first segment, second segment, and third segment, said first segment containing said slot, said first segment joined to said second segment at a first angle, said second segment joined to said third segment at a second angle, such that when said first segment and second segment are inserted into said hollow, said frame is locked in said second mode and when said second segment is lifted above a narrowest width of said cutout, said frame is unlocked from said second mode.

20. The portable receptacle of claim 18 wherein a foot is attached to said lower portion of said legs, said upper portion of said legs is dimensioned to receive said foot for stacking said platform.

21. An exchange system for bodies and covers of receptacles comprising a computing environment comprising at least one central processing unit, memory and an interface interconnected by a bus; said central processing unit configured to receive, via said interface, first data representing a first order for at least one body for a receptacle; said first order originating from a first entity and comprising first compensatory terms; said central processing unit configured to receive, via said interface, second data representing a second order for at least one cover for said receptacle; said first order originating from a second entity and comprising second compensatory terms; said central processing unit configured to perform a comparison of said first data and said second data and to perform an adjustment said first compensatory terms based said comparison; said central processing unit configured to generate third data representing said first order including said adjustment and said second order.

22. A receptacle comprising:
a body having a platform and a frame connected to said platform; said frame movable between a collapsed position and an raised position in relation to said frame; said platform configured to support at least one bin; and,
a cover configured to rest on said frame when said frame is in said raised position; said cover comprising at least one opening providing access to said bin; said cover removable from said frame.

23. A cover for a receptacle, said receptacle including a frame and a support for at least one bin; said cover comprising a material configured to rest on said frame and further comprising at least one opening providing access to said bin; said cover removable from said frame.
